(19) United States
(12) Patent Application Publication
(10) Pub. No.: US 2023/0089537 A1
(43) Pub. Date: Mar. 23, 2023

(54) DIETARY SUPPLEMENT AND METHOD FOR SYNTHESIS OF SAME

(71) Applicant: StrongCell LLC, Plano, TX (US)

(72) Inventor: Jason R. Wynn, Plano, TX (US)

(21) Appl. No.: 17/933,802

(22) Filed: Sep. 20, 2022

Related U.S. Application Data
(60) Provisional application No. 63/246,266, filed on Sep. 20, 2021.

(51) Int. Cl. A23L 33/13; A23L 33/15; A23L 33/16; A23L 33/17

(52) U.S. Cl. CPC A23L 33/13; A23L 33/15; A23L 33/16; A23L 33/17

(57) ABSTRACT

A dietary supplement and method for synthesis of the same are disclosed. In one embodiment of the method, an NADH component is provided which includes NADH from about 0.1% to about 0.5% blended with water from about 40% to about 84% both by weight of the dietary supplement. A supplement component from about 9% to about 99% by weight of the dietary supplement is also provided. The supplement component may include collagen in about 2% to about 10%, vitamins in about 0.00001% to about 3%, and minerals in about 0.000002% to about 0.5% all by weight of the dietary supplement. A mixed component is formed by mixing the NADH component with the supplement component at ambient conditions. The mixed component is a liquid at ambient conditions having a pH of less than 4.0. The mixed component is subjected to a cold fill production process.

### PRIORITY STATEMENT & CROSS-REFERENCE TO RELATED APPLICATIONS

This application claims priority from co-pending U.S. Patent Application No. 63/246,266, entitled “Dietary Supplement and Method for Synthesis of Same” and filed on Sep. 20, 2022, in the name of Jason R. Wynn; which is hereby incorporated by reference, in entirety, for all purposes.

### TECHNICAL FIELD OF THE INVENTION

This invention relates, in general, to dietary supplements and, in particular, to a dietary supplement having a composition containing NADH and method for synthesis of the same to provide increased dietary efficacy.

### BACKGROUND OF THE INVENTION

NADH, or reduced nicotinamide adenine dinucleotide, is naturally made in the body from niacin, a type of B vitamin. NADH plays a role in generating energy in the body and may be taken in supplement form. Proponents of supplements containing NADH advocate that NADH can boost energy levels and improve mental clarity, alertness, concentration, memory, athletic performance, and endurance. The health benefits of existing solid-pill-based supplements containing NADH have been limited, however, as the human digestive systems doesn't fully absorb the NADH, thereby reducing efficacy. Alternative intravenous-based delivery systems have proven expensive and, in many instances, require a nurse or other medical practitioner to deliver the supplement. Improvements in dietary supplements are therefore needed.

### SUMMARY OF THE INVENTION

It would be advantageous to provide dietary supplements that have greater absorption and efficacy. It would also be desirable to enable a chemical-based solution for a dietary supplement having a composition containing NADH and method for synthesis of the same that furnishes an approachable and affordable product. It would be further desirable to enable a chemical-based solution providing a dietary supplement in liquid form. To better address one or more of these concerns, a dietary supplement and method for synthesis of the same are disclosed. In one embodiment of the method, an NADH component is provided which includes NADH from about 0.1% to about 0.5% by weight of the dietary supplement blended with water from about 40% to about 84% by weight of the dietary supplement. A supplement component from about 9% to about 99% by weight of the dietary supplement is also provided. The supplement component may include collagen in about 2% to about 10% by weight of the dietary supplement, vitamins in about 0.00001% to about 3% by weight of the dietary supplement, and minerals in about 0.000002% to about 0.5% by weight of the dietary supplement. A mixed component is formed by mixing the NADH component with the supplement component at ambient conditions. The mixed component is a liquid at ambient conditions having a pH of less than 4.0. The mixed component is subjected to a cold fill production process. These and other aspects of the invention will be apparent from and elucidated with reference to the embodiments described hereinafter.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is a flow diagram depicting one embodiment of a method for synthesis of a dietary supplement, according to the teachings presented herein.

### DETAILED DESCRIPTION OF THE INVENTION

While the making and using of various embodiments of the present invention are discussed in detail below, it should be appreciated that the present invention provides many applicable inventive concepts, which can be embodied in a wide variety of specific contexts. The specific embodiments discussed herein are merely illustrative of specific ways to make and use the invention, and do not delimit the scope of the present invention.

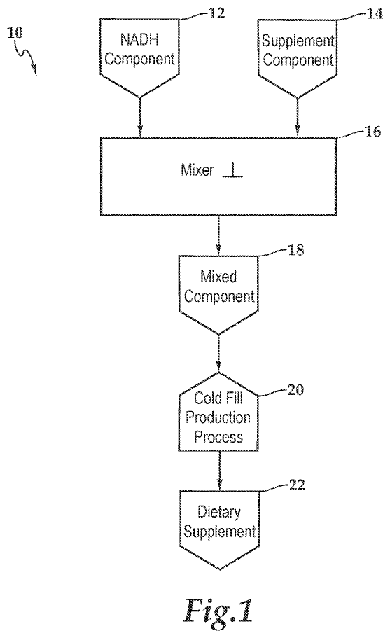

Referring initially to FIG. 1, therein is depicted one embodiment of a method for the synthesis of a dietary supplement and the like, which is generally designated 10. An NADH component 12 and a supplement component 14, with or without water as a carrier, are provided to a mixer 16, which provides agitation. In one implementation, the mixing occurs at ambient conditions. Following the mixing, a mixed component 18 is provided that may undergo a cold fill production process 20 to yield a dietary supplement 22. During the cold fill process, a container or containers receive the mixed component 18 at ambient conditions or cold pressurized conditions to yield the dietary supplement 20. Then the cold product is added to the cold container. The cold fill production process also requires sterilization, which can be either a wet or dry sterilization. The various mixing and filling steps represented in FIG. 1 may be carried out in known commercial equipment currently used in the conventional dietary supplement production processes. Further, it should be appreciated that although a particular architecture and design of manufacturing equipment is illustrated and described in FIG. 1, other architectures and designs of manufacturing equipment are within the teachings presented herein.

As depicted in FIG. 1, the method 10 includes mix-fill production equipment configured to receive the NADH component 12 and the supplement component 14 to produce the dietary supplement 22. The dietary supplement may have a pH of less than 4.0 in some embodiments and in other embodiments, the pH is less than 3.8. The low, acidic pH acts as preservative and stabilizing mechanism enabling the dietary supplement 22 to avoid deterioration in the stomach and have high absorption in the intestines. In one embodiment, the NADH component includes NADH from about 0.1% to about 0.5% by weight of the dietary supplement blended with water from about 40% to about 84% by weight of the dietary supplement. In another embodiment, the NADH component includes NADH from about 0.1% to about 0.25% by weight of the dietary supplement blended with water from about 40% to about 84% by weight of the dietary supplement. In a further embodiment, the NADH component includes NADH from about 0.1% to about 0.3% by weight of the dietary supplement blended with water from about 40% to about 84% by weight of the dietary supplement.

Nicotinamide-adenine-dinucleotide in its reduced form (“NADH”) and nicotinamide-adenine-phosphate-dinucleotide in its reduced form (“NADPH”) are physiological substances which occur in all living cells including human cells. These substances are cofactors for a variety of enzymes, the majority of which catalyze oxidation-reduction reactions. The most important function of NADH is its driving force for cell respiration. When using oxygen, NADH forms water and 3 ATP molecules in accordance with the following formula:

NADH+H+½O₂+3Pi+3ATP→NAD+3ATP+4H₂O.

Thus, with 1 NADH molecule, 3 ATP molecules are obtained which have an energy of approximately 21 kilocalories. This process is called oxidative phosphorylation. The supply of NADH and/or NADPH improves energy production.

The NADH component, further comprises furnishing polysorbate 80. In one embodiment, the polysorbate 80 may be from about 0.0001% to about 2% by weight of the dietary supplement. In another embodiment, the polysorbate 80 may be from about 0.0001% to about 1.5% by weight of the dietary supplement. In a further embodiment, the polysorbate 80 may be from about 0.0001% to about 1% by weight of the dietary supplement.

In one embodiment, the supplement component includes at least one of collagen, coenzyme Q10, vitamins, preservatives, D-ribose, and minerals. The supplement component may be from about 9% to about 99% by weight of the dietary supplement. Alternatively, the supplement component may be from about 11% to about 89% by weight of the dietary supplement. As a further alternative, the supplement may be from about 13% to about 84% by weight of the dietary supplement.

The collagen may be collagen hydrolysate (as, for example, bovine). Further, the supplement component may include collagen in about 2% to about 10% by weight of the dietary supplement. In another embodiment, collagen may be provided in about 4% to about 8% by weight of the dietary supplement. In a further embodiment, the supplement component may include collagen in about 5% to about 7% by weight of the dietary supplement.

With respect to coenzyme Q10, in some embodiments, the supplement component may include coenzyme Q10 in about 1% to about 3% by weight of the dietary supplement. In other embodiments, the supplement component may include coenzyme Q10 in about 1% to about 2% by weight of the dietary supplement. In still other embodiments, the supplement component may include coenzyme Q10 in about 1% to about 2.2% by weight of the dietary supplement.

With respect to vitamins, the vitamins may be at least one of Biotin, Vitamin K2 (as, for example, menaquinone-7), Vitamin B1, Vitamin B2, Vitamin B3, Vitamin B5, Vitamin B6, Vitamin B12, Vitamin D, Vitamin E, and Vitamin K1 (as, for example, phylloquinone). In some embodiments, the vitamins are provided in about 0.00001% to about 3% by weight of the dietary supplement. In some other embodiments, the vitamins are provided in about 0.00001% to about 0.84% by weight of the dietary supplement. In some still other embodiments, the vitamins are provided in about 0.12% to about 0.35% by weight of the dietary supplement.

With respect to the preservatives, one or more of ascorbic acid, sodium benzoate, potassium sorbate, acesulfame K, sucralose, and steviol glycoside may be utilized. The preservatives may be utilized in some embodiments in about 0.0006% to about 12% by weight of the dietary supplement. The preservatives may be utilized in other embodiments in about 0.0006% to about 9% by weight of the dietary supplement. In still other embodiments, preservatives may be provided in about 0.0006% to about 6% by weight of the dietary supplement.

The D-ribose may be provided in about 2% to about 8% by weight of the dietary supplement in some embodiments. In other embodiments, the D-ribose may be provided in about 2% to about 6% by weight of the dietary supplement. In still further embodiments, the D-ribose may be provided in about 3% to about 5% by weight of the dietary supplement.

With respect to minerals, at least one of zinc and selenium may be selected. In some embodiments, the minerals may be provided in about 0.000002% to about 0.5% by weight of the dietary supplement in some embodiments. In some other embodiments, the minerals may be provided in about 0.000002% to about 0.12% by weight of the dietary supplement. In some other embodiments, the minerals may be provided in about 0.001% to about 0.021% by weight of the dietary supplement.

The dietary supplement is a thick liquid which furnishes a liquid NADH dietary supplement. As NADH serves as the power source to every living cell in the human body and as NADH production generally declines with age, the dietary supplement presented herein provides the body with necessary fuel. Proponents of the dietary supplement presented herein advocate that the dietary supplement boosts energy levels and improves mental clarity, alertness, concentration, memory, athletic performance, and endurance, among other benefits.

It should be appreciated that the selections of the composition of the supplement component, including the aforementioned collagen, coenzyme Q10, vitamins, preservatives, D-ribose, and minerals, may vary from the exemplary presentations above and still be within the teachings presented herein. The present invention will now be illustrated by reference to the following non-limiting working examples wherein procedures and materials are solely representative of those which can be employed and are not exhaustive of those available and operative. Tables I-III and Example I illustrates general and specific examples of utilizing NADH in a dietary supplement that includes additional vitamins and minerals to not only provide a liquid for human consumption and nutrition, but to increase efficiency and absorption of NADH and additional vitamins and minerals as well. The following glossary enumerates the components utilized in the Tables and Examples presented hereinbelow.

ACESULFAME POTASSIUM, also known as acesulfame K or Ace K, is a calorie-free sugar substitute. ASCORBIC ACID is an oxidation-reduction catalyst; vitamin C.

BIOTIN is 2′-keto-3,4-imidazolido tetradydrothiophene-n-valeric acid and a member of the vitamin B complex; vitamin H.

CALCIUM PANTOTHENATE is the calcium salt of pantothenic acid or Ca(C₁₅H₃₁CO₂)₂

CHOLECALCIFEROL is activated 7-dehydrocholesterol or C₂₇H₄₄O, which is Vitamin D3.

COENZYME Q10 is CH₃C₆ (O)₂ (OCH₃)₂[CH₂CH:C(CH₃)CH₂]₁₀H.

COLLAGEN HYDROLYSATE (as, for example, BOVINE) is a fibrous protein constituting most of the white fiber in connective tissues of animals of the biological subfamily Bovinae.

CYANOCOBALAMIN is C₆₃H₈₈CoN₁₄O₁₄P or vitamin B12.

D-RIBOSE is D-ribose-5-phosphoric acid or C₅H₉O₄.H₂PO₄., which is a constituent of nucleotides and nucleic acids.

DI-ALPHA TOCOPHERYL ACETATE is C₃₁H₅₂O₃, which is a synthetic form of vitamin E.

GLUCONIC ACID is CH₂OH(CH₂O)₄COOH.

MALIC ACID is hydroxysuccinic acid or COOHCH₂CH(OH)COOH.

MENAQUINONE-₇ is C₄₆H₆₄O₂; vitamin K2.

NADH is C₂₂H₂₇O₁₄N₇P₂ or nicotinamide adenine dinucleotide; which in its reduced form is NADPH or nicotinamide adenine phosphate dinucleotide.

NIACIN is pyridine-carboxylic acid, which is an antipellagra vitamin.

NIACINAMIDE is C₅N₄NCONH₂, which is a conversion of niacin to the amide.

ORANGE JUICE CONCENTRATE is product of fresh oranges made by squeezing the juice from the fresh oranges then removing a large percentage of water. Pasteurization may then occur. Orange juice concentrate may include additives such as sugar, water, and nectars.

PANTOTHENIC ACID is N-(2-4-dihydroxy-3,3-dimethylbutyryl)-β-alanine, which is a member of the vitamin-B complex.

PHYLLOQUINONE also known as phytomenadione is C₃₁H₄₆O₂, which is vitamin K1.

POLYSORBATE 80 is polyoxyethylene (20) sorbitan monooleate, which is one of a group of nonionic surfactants obtained by esterification of sorbitol with one or three molecules of a fatty acid.

POTASSIUM SORBATE is potassium-2,4-hexadienoate.

PYRIDOXINE is 3-hydroxy-4,5-dimethylol methylpyridine, which is vitamin B6.

PYRIDOXINE HYDROCHLORIDE is the hydrochloride salt form of pyridoxine.

RIBOFLAVIN is 7,8-dimethyl-10(1′-d-ribityl) isoalloxazine or vitamin B2.

SELENIUM is a nonmetallic element, atomic number 34.

SODIUM BENZOATE is C₆H₅COONa.

SODIUM RIBOFLAVIN 5-PHOSPHATE is the sodium salt form of riboflavin.

SODIUM SELENITE is Na₂SeO₃.5H₂O.

SUCRALOSE is C₁₂H₁₉C₁₃O₈, which is an artificial sweetener and sugar substitute.

STEVIOL GLYCOSIDES are chemical compounds derived from the leaves of the South American plant Stevia rebaudiana (as, for example, Asteraceae).

THIAMIN is C₁₂H₁₇CIN₄OS, which is vitamin B1.

THIAMIN MONONITRATE is a synthetic nitrate salt form of thiamin.

VITAMIN B6 is pyridoxine.

VITAMIN B12 is cyanocobalamin.

VITAMIN D is cholecalciferol.

VITAMIN E is di-alpha tocopheryl acetate.

VITAMIN K1 is phylloquinone.

WATER is H₂O.

ZINC is a metallic element with atomic number 30.

ZINC GLUCONATE is the zinc salt of gluconic acid.

A dietary supplement may be prepared having a composition as defined in the ranges provided in Table I.

TABLE I
Composition of Dietary Supplement

| Some Embodiments of | Percent of Total |
|---|---|
| Preferred Ranges*. | by Weight |
| Vitamin D (as, for | 0.000001%-0.25% |
| example, | |
| cholecalciferol) | |
| Vitamin E (as, for | 0.000001%-0.5% |
| example, di-alpha | |
| tocopheryl acetate) | |
| Vitamin K1 (as, for | 0.000001%-0.25% |
| example, phylloquinone) | |
| Thiamin (as, for | 0.000001%-0.25% |
| example, thiamin | |
| mononitrate) | |
| Riboflavin (as, for | 0.000001%-0.25% |
| example, sodium | |
| riboflavin 5-phosphate) | |
| Niacin (as, for example, | 0.000001%-0.25% |
| niacinamide) | |
| Vitamin B6 (as, for | 0.000001%-0.25% |
| example, pyridoxine | |
| hydrochloride) | |
| Vitamin B12 (as, for | 0.000001%-0.25% |
| example, cyanocobalamin) | |
| Biotin | 0.000001%-0.25% |
| Pantothenic acid (as, | 0.000001%-0.25% |
| for example, calcium | |
| pantothenate) | |
| Zinc (as, for example, | 0.000001%-0.25% |
| zinc gluconate) | |
| Selenium (as sodium | 0.000001%-0.25% |
| selenite) | |
| Vitamin K2 (as, for | 0.000001%-0.25% |
| example, menaquinone-7) | |
| Collagen hydrolysate | 2%-10% |
| (as, for example, | |
| bovine) | |
| D-ribose | 2%-8% |
| Coenzyme Q10 | 1%-3% |
| NADH | 0.1%-0.5% |
| Orange juice concentrate | 2%-60% |
| Malic acid | 2%-3.4% |
| Ascorbic acid | 0.0001%-2% |
| Sodium benzoate | 0.0001%-2% |
| Potassium sorbate | 0.0001%-2% |
| Polysorbate 80 | 0.0001%-2% |
| Acesulfame K | 0.0001%-2% |
| Sucralose | 0.0001%-2% |
| Steviol glycosides | 0.0001%-2% |
| Water | Adjusted to above % or 40%-84% |

*Please note that all ranges in Table I are expressed as “about.” By way of example, with respect to Biotin, the range is about 0.000001% to about 0.25%. By way of a second example, with respect to coenzyme Q10, the range is about 1% to about 3%. Additionally, please note that modifiers such as “(as, for example, cholecalciferol)” with respect to Vitamin D are exemplary and non-limiting examples for the formulation.

A dietary supplement may be prepared having a composition as defined in the ranges provided in Table II.

TABLE II
Composition of Dietary Supplement

| Some Embodiments of | Percent of Total |
|---|---|
| Preferred Ranges*. | by Weight |
| Vitamin D (as, for | 0.000001%-0.002% |
| example, | |
| cholecalciferol) | |
| Vitamin E (as, for | 0.000001%-0.4% |
| example, di-alpha | |
| tocopheryl acetate) | |
| Vitamin K1 (as, for | 0.000001%-0.03% |
| example, phylloquinone) | |
| Thiamin (as, for | 0.000001%-0.04% |
| example, thiamin | |
| mononitrate) | |
| Riboflavin (as, for | 0.000001%-0.05% |
| example, sodium | |
| riboflavin 5-phosphate) | |
| Niacin (as, for example, | 0.000001%-0.02% |
| niacinamide) | |
| Vitamin B6 (as, for | 0.000001%-0.05% |
| example, pyridoxine | |
| hydrochloride) | |
| Vitamin B12 (as, for | 0.000001%-0.005% |
| example, cyanocobalamin) | |
| Biotin | 0.000001%-0.002% |
| Pantothenic acid (as, | 0.000001%-0.2% |
| for example, calcium | |
| pantothenate) | |
| Zinc (as, for example, | 0.000001%-0.1% |
| zinc gluconate) | |
| Selenium (as, for | 0.000001%-0.02% |
| example, sodium | |
| selenite) | |
| Vitamin K2 (as, for | 0.000001%-0.04% |
| example, menaquinone-7) | |
| Collagen hydrolysate | 4%-8% |
| (as, for example, | |
| bovine) | |
| D-ribose | 2%-6% |
| Coenzyme Q10 | 1%-2% |
| NADH | 0.1%-0.25% |
| Orange juice concentrate | 2%-60% |
| Malic acid | 2%-3% |
| Ascorbic acid | 0.0001%-1.5% |
| Sodium benzoate | 0.0001%-1.5% |
| Potassium sorbate | 0.0001%-1.5% |
| Polysorbate 80 | 0.0001%-1.5% |
| Acesulfame K | 0.0001%-1.5% |
| Sucralose | 0.0001%-1.5% |
| Steviol glycosides | 0.0001%-1.5% |
| Water | Adjusted to above % or 40%-84% |

*Please note that all ranges in Table I are expressed as “about.” By way of example, with respect to Biotin, the range is about 0.000001% to about 0.002%. By way of a second example, with respect to coenzyme Q10, the range is about 1% to about 2%. Additionally, please note that modifiers such as “(as, for example, cholecalciferol)” with respect to Vitamin D are exemplary and non-limiting examples for the formulation.

A dietary supplement may be prepared having a composition as defined in the ranges provided in Table III.

TABLE III
Composition of Dietary Supplement

| Some Embodiments of | Percent of Total |
|---|---|
| Preferred Ranges*. | by Weight |
| Vitamin D (as, for | 0.00001%-0.00003% |
| example, | |
| cholecalciferol) | |
| Vitamin E (as, for | 0.1%-0.3% |
| example, di-alpha | |
| tocopheryl acetate) | |
| Vitamin K1 (as, for | 0.0002%-0.0004% |
| example, phylloquinone) | |
| Thiamin (as, for | 0.003%-0.005% |
| example, thiamin | |
| mononitrate) | |
| Riboflavin (as, for | 0.004%-0.006% |
| example, sodium | |
| riboflavin 5-phosphate) | |
| Niacin (as, for example, | 0.0001%-0.0003% |
| niacinamide) | |
| Vitamin B6 (as, for | 0.004%-0.006% |
| example, pyridoxine | |
| hydrochloride) | |
| Vitamin B12 (as, for | 0.00004%-0.00006% |
| example, cyanocobalamin) | |
| Biotin | 0.00001%-0.00003% |
| Pantothenic acid (as, | 0.01%-0.03% |
| for example, calcium | |
| pantothenate) | |
| Zinc (as, for example, | 0.001%-0.02% |
| zinc gluconate) | |
| Selenium (as, for | 0.0001%-0.0003% |
| example, sodium | |
| selenite) | |
| Vitamin K2 (as, for | 0.0003%-0.0005% |
| example, menaquinone-7) | |
| Collagen hydrolysate | 5%-7% |
| (as, for example, | |
| bovine) | |
| D-ribose | 3%-5% |
| Coenzyme Q10 | 1%-2.2% |
| NADH | 0.1%-0.3% |
| Orange juice concentrate | 2%-60% |
| Malic acid | 2%-3.4% |
| Ascorbic acid | 0.0001%-1% |
| Sodium benzoate | 0.0001%-1% |
| Potassium sorbate | 0.0001%-1% |
| Polysorbate 80 | 0.0001%-1% |
| Acesulfame K | 0.0001%-1% |
| Sucralose | 0.0001%-1% |
| Steviol glycosides | 0.0001%-1% |
| Water | Adjusted to above % or 40%-84% |

*Please note that all ranges in Table I are expressed as “about.” By way of example , with respect to Biotin, the range is about 0.00001% to about 0.00003%. By way of a second example, with respect to coenzyme Q10, the range is about 1% to about 2.2%. Additionally, please note that modifiers such as “(as, for example, cholecalciferol)” with respect to Vitamin D are exemplary and non-limiting examples for the formulation.

Example I. A dietary supplement with a serving size of one bottle being 0.85 fluid ounces (≈25 mL) was prepared according to the formulations provided in Tables I, II, and III as Preparation 1, as shown in Table IV:

TABLE IV
Composition of Dietary Supplement

| Compound | Amount Per Serving | |
|---|---|---|
| Vitamin D (as, for example, | 5 | mcg |
| cholecalciferol) | | |
| Vitamin E (as, for example, | 60 | mg |
| di-alpha tocopheryl acetate) | | |
| Vitamin K1 (as, for example, | 75 | mcg |
| phylloquinone) | | |
| Thiamin (as, for example, | 1.1 | mg |
| thiamin mononitrate) | | |
| Riboflavin (as, for example, | 1.4 | mg |
| sodium riboflavin 5-phosphate) | | |
| Niacin (as, for example, | 16 | mg |
| niacinamide) | | |
| Vitamin B6 (as, for example, | 1.4 | mg |
| pyridoxine hydrochloride) | | |
| Vitamin B12 (as, for example, | 13 | mg |
| cyanocobalamin) | | |
| Biotin | 5 | mg |
| Pantothenic acid (as, for | 6 | mg |
| example, calcium pantothenate) | | |
| Zinc (as, for example, zinc | 2.5 | mg |
| gluconate) | | |
| Selenium (as, for example, | 55 | mcg |
| sodium selenite) | | |
| Vitamin K2 (as menaquinone-7) | 75 | mcg |
| Collagen hydrolysate (as, for | 1,560 | mg |
| example, bovine) | | |
| D-ribose | 1,000 | mg |
| Coenzyme Q10 | 420 | mg |
| NADH | 40 | mg |

Other ingredients include orange juice concentrate, malic acid, ascorbic acid, sodium benzoate, potassium sorbate, polysorbate 80 (which may form a portion of the NADH component), acesulfame K, sucralose, steviol glycosides, and water.

The NADH and water components of Preparation 1 were mixed together and sufficiently blended to form a fluid at ambient conditions. The resulting NADH component was mixed with the remaining ingredients as a supplement component at ambient conditions and subjected to a cold fill production process of the type described in FIG. 1.

With respect to Example I and corresponding Preparation 1, in use, the dietary supplement was found to have the nutritional value expressed in Table V.

TABLE V
Nutritional Value of Dietary Supplement

| Compound | % Daily Value |
|---|---|
| Vitamin D (as, for | 25% |
| example, | |
| cholecalciferol) | |
| Vitamin E (as, for | 400% |
| example, di-alpha | |
| tocopheryl acetate) | |
| Vitamin K1 (as, for | 63% |
| example, phylloquinone) | |
| Thiamin (as, for | 92% |
| example, thiamin | |
| mononitrate) | |
| Riboflavin (as, for | 108% |
| example, sodium | |
| riboflavin 5-phosphate) | |
| Niacin (as, for example, | 100% |
| niacinamide) | |
| Vitamin B6 (as, for | 82% |
| example, pyridoxine | |
| hydrochloride) | |
| Vitamin B12 (as, for | 542% |
| example, cyanocobalamin) | |
| Biotin | 17% |
| Pantothenic acid (as, | 120% |
| for example, calcium | |
| pantothenate) | |
| Zinc (as, for example, | 23% |
| zinc gluconate) | |
| Selenium (as, for | 100% |
| example, sodium | |
| selenite) | |
| Vitamin K2 (as, for | Daily value not established |
| example, menaquinone-7) | |
| Collagen hydrolysate | Daily value not established |
| (as, for example, | |
| bovine) | |
| D-ribose | Daily value not established |
| Coenzyme Q10 | Daily value not established |
| NADH | Daily value not established |

The dietary supplement was a thick liquid, with a bright orange color and opaque appearance, consumed by pouring the one serving into ½ cup (4 fluid ounces or ≈118 mL) of water. The absorption rate of NADH was estimated over 98%. Users of the dietary supplement presented herein reported that the dietary supplement boosts energy levels and improves mental clarity, alertness, concentration, memory, athletic performance, and endurance, among other benefits.

The order of execution or performance of the methods and processes illustrated and described herein is not essential, unless otherwise specified. That is, elements of the methods and processes may be performed in any order, unless otherwise specified, and that the methods may include more or less elements than those disclosed herein. For example, it is contemplated that executing or performing a particular element before, contemporaneously with, or after another element are all possible sequences of execution.

While this invention has been described with reference to illustrative embodiments, this description is not intended to be construed in a limiting sense. Various modifications and combinations of the illustrative embodiments as well as other embodiments of the invention, will be apparent to persons skilled in the art upon reference to the description. It is, therefore, intended that the appended claims encompass any such modifications or embodiments.

What is claimed is:

1. A method for synthesis of a dietary supplement, the method comprising:
providing an NADH component including NADH from about 0.1% to about 0.5% by weight of the dietary supplement blended with water from about 40% to about 84% by weight of the dietary supplement;
providing a supplement component from about 9% to about 99% by weight of the dietary supplement;
forming a mixed component by mixing the NADH component with the supplement component at ambient conditions, the mixed component being a liquid at the ambient conditions having a pH of less than 4.0; and
subjecting the mixed component to a cold fill production process.

2. The method as recited in claim 1, wherein providing the NADH component, further comprises furnishing NADH from about 0.1% to about 0.25% by weight of the dietary supplement.

3. The method as recited in claim 1, wherein providing the NADH component, further comprises furnishing NADH from about 0.1% to about 0.3% by weight of the dietary supplement.

4. The method as recited in claim 1, wherein providing the NADH component, further comprises furnishing polysorbate 80 from about 0.0001% to about 2% by weight of the dietary supplement.

5. The method as recited in claim 1, wherein providing the NADH component, further comprises furnishing polysorbate 80 from about 0.0001% to about 1.5% by weight of the dietary supplement.

6. The method as recited in claim 1, wherein providing the NADH component, further comprises furnishing polysorbate 80 from about 0.0001% to about 1% by weight of the dietary supplement.

7. The method as recited in claim 1, wherein the pH is less than 3.8.

8. The method as recited in claim 1, wherein providing the supplement component, further comprises providing collagen in about 2% to about 10% by weight of the dietary supplement.

9. The method as recited in claim 1, wherein providing the supplement component, further comprises providing collagen in about 4% to about 8% by weight of the dietary supplement.

10. The method as recited in claim 1, wherein providing the supplement component, further comprises providing collagen in about 5% to about 7% by weight of the dietary supplement.

11. The method as recited in claim 1, wherein providing the supplement component, further comprises providing collagen hydrolysate.

12. The method as recited in claim 1, wherein providing the supplement component, further comprises providing Coenzyme Q10 in about 1% to about 3% by weight of the dietary supplement.

13. The method as recited in claim 1, wherein providing the supplement component, further comprises providing Coenzyme Q10 in about 1% to about 2% by weight of the dietary supplement.

14. The method as recited in claim 1, wherein providing the supplement component, further comprises providing Coenzyme Q10 in about 1% to about 2.2% by weight of the dietary supplement.

15. The method as recited in claim 1, wherein providing the supplement component, further comprises providing vitamins.

16. The method as recited in claim 12, wherein the vitamins are selected from the group consisting of Biotin, Vitamin K2, Vitamin B1, Vitamin B2, Vitamin B3, Vitamin B5, Vitamin B6, Vitamin B12, Vitamin D, Vitamin E, and Vitamin K1.

17. The method as recited in claim 1, wherein providing the supplement component, further comprises providing D-ribose.

18. The method as recited in claim 1, wherein providing the supplement component, further comprises providing minerals.

19. A method for synthesis of a dietary supplement, the method comprising:
providing an NADH component including NADH from about 0.1% to about 0.25% by weight of the dietary supplement blended with water from about 40% to about 84% by weight of the dietary supplement;
providing a supplement component from about 11% to about 89% by weight of the dietary supplement, the supplement component including collagen in about 4% to about 8% by weight of the dietary supplement, the supplement component including vitamins in about 0.00001% to about 0.84% by weight of the dietary supplement, the supplement component including minerals in about 0.000002% to about 0.12% by weight of the dietary supplement;
forming a mixed component by mixing the NADH component with the supplement component at ambient conditions, the mixed component being a liquid at the ambient conditions having a pH of less than 4.0; and
subjecting the mixed component to a cold fill production process.

20. A method for synthesis of a dietary supplement, the method comprising:
providing an NADH component including NADH from about 0.1% to about 0.3% by weight of the dietary supplement blended with water from about 40% to about 84% by weight of the dietary supplement;
providing a supplement component from about 13% to about 84% by weight of the dietary supplement, the supplement component including collagen in about 5% to about 7% by weight of the dietary supplement, the supplement component including vitamins in about 0.12% to about 0.35% by weight of the dietary supplement, the supplement component including minerals in about 0.001% to about 0.021% by weight of the dietary supplement;
forming a mixed component by mixing the NADH component with the supplement component at ambient conditions, the mixed component being a liquid at the ambient conditions having a pH of less than 4.0; and
subjecting the mixed component to a cold fill production process.
